(19) United States
(12) Patent Application Publication
(10) Pub. No.: US 2013/0339598 A1
(43) Pub. Date: Dec. 19, 2013

(54) Intelligent Active Vault Operation

(71) Applicant: Roderick B. Wideman, Shakopee, MN (US)

(72) Inventor: Roderick B. Wideman, Shakopee, MN (US)

(73) Assignee: Quantum Corpoaration, San Jose, CA (US)

(21) Appl. No.: 13/523,813

(22) Filed: Jun. 14, 2012

(51) Int. Cl. G06F 12/00

(52) U.S. Cl. 711/111; 711/E12.001

(57) ABSTRACT

Example apparatus, methods, and other embodiments concern a tape library controller (TLC) configured to examine import and export commands to provide more intelligent active vault support. One example method may include receiving a command in a TLC associated with a tape library that is configured with an active archive and an active vault. The example method may include determining that the command can be satisfied by one of, an operation involving the active vault, and an operation involving an external vault. The example method may then control the TLC to provide a request that seeks the vault destination to be used to satisfy the command. The example method may also include receiving an identifier of the vault destination in the TLC and controlling the tape library to move a tape to or from the active vault or the external vault based on the vault destination identifier.

### BACKGROUND

A user may have data that is managed by a data management application. The managed data may be stored on a physical device(s). Therefore a data management application may interface with a data storage device(s) (e.g., disk drive, tape drive, tape library). Conventionally the data management application may provide control and data to storage devices and the storage devices may provide status and data back to the management application.

A data management application may provide a file access service along with, for example, a policy based tiered storage and archiving service. Providing a file access service may involve, for example, maintaining a name space for a data set so that a file can be located and so that data can be retrieved from that file. Providing a tiered storage and archiving service may include, for example, storing data in memory, on disk, and on tape and may also include moving data between memory, disk, tape, and other devices. Thus, providing file access may include configuring the name space to handle files and data stored on multiple different types of devices in multiple different locations.

Storing and managing data is not free. There may be a cost associated with storing data and there may be a cost associated with managing data. The costs may vary depending, for example, on whether the data is in memory, whether the data is on disk, whether the data is on tape in a tape library, whether the data is on tape but not in a tape library, and on other factors. For example, data that is in memory may be more expensive than data that is on disk and data that is on disk may be more expensive than data that is on tape. In addition to the cost of storing the data, there may be a cost associated with managing the data. For example, a fee may be charged to maintain the namespace for the data.

Given that there may be costs, users may be interested in managing those costs. Users may be interested in managing both the cost to store their data and the cost to manage their data. In an attempt to reduce costs, users may configure data management applications or may take actions to move data from an automated or managed state where the data is available without a manual intervention to a not automated or unmanaged state where the data is only available after a manual intervention (e.g., providing tape to tape library). By way of illustration, users may configure data management applications or may request data management applications to move data from memory to disk and from disk to a tape. Additionally, users may configure data management applications or may request data management applications to move a tape from a tape drive to a tape storage slot in a tape library or even to remove the tape from the tape library. When a tape is removed from a tape library it is said to have been put “in the vault”, even if it has just been put on a shelf or in a drawer. This vault located outside the tape library will be referred to as an external vault. Removing a tape from a tape library may expose the tape to undesirable environmental factors including, for example, heat, dust, humidity, loss, theft, mishandling, electrical fields, magnetic fields, and other factors.

A tape library has physical tape drives, physical slots for storing tapes, computerized processes that process physical tapes, and a mechanism for removing a tape from the library or for adding a tape to the library. Conventionally, a tape library has treated all slots as equal and has, therefore, made all slots available for an active partition. The cost for using any slot was the same as the cost for using any other slot.

Recently, some tape libraries have been logically divided into portions including a first portion for tapes actively being used and a second portion for an in-library “vault” for tapes that are not as active. The first portion may be referred to as an active archive and the second portion may be referred to as an active vault. If a tape can be maintained in the “active vault” inside a tape library, then that tape may be spared from exposure to the undesirable environmental factors. Slots in the active vault may be priced less expensively than slots in the active archive. This logically divided tape library, which includes variable pricing for slots in the different divisions, provides a vehicle for users to keep tapes in the tape library while still managing costs. Keeping tapes in the tape library reduces opportunities for tapes to be mishandled, lost, or exposed to undesirable environmental conditions.

Unfortunately, some users may attempt to “game” their data storage and management costs by micro-managing the tape library portion of the tiered storage provided by their data management software. The micro-management or gaming may arise when users are charged for how much data they have automated. Users may wish to minimize this charge by moving data from a managed or automated state to an unmanaged or not automated state. The micro-management may also arise when users are charged for the number of tapes they have in a tape library or for a maximum number of slots reserved for the user in the tape library. Users may wish to minimize this charge by removing tapes from the tape library to achieve keeping a minimum number of tapes in the tape library so that they can license fewer slots. Unfortunately, this combination of incentives may lead to data being moved between states more often than desired and may also lead to tapes being removed from and added to the tape library more frequently than desired.

Conventionally, a tape library has been a target for commands from applications. Tape libraries have received commands and have done what they are commanded to do. For example, in response to a command, a tape library may perform a desired action (e.g., move tape from slot to drive, move tape from drive to slot, eject tape from tape library), may provide requested data, or may provide limited information (e.g., status, error signal, capacity information, tape health information).

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a tape library.

FIG. 2 illustrates a tape library configured with an active archive and an active vault.

FIG. 3 illustrates an export command being handled by a tape library.

FIG. 4 illustrates an export command being handled by a tape library.

FIG. 5 illustrates an export command being handled by a tape library.

FIG. 6 illustrates a message sequence associated with an example tape library controller (TLC).

FIG. 7 illustrates a message sequence associated with an example TLC leading to an external vault operation.

FIG. 8 illustrates a message sequence associated with an example TLC leading to an active vault operation.

FIG. 9 illustrates an example method.

FIG. 10 illustrates an example method.

FIG. 11 illustrates an example TLC.

### DETAILED DESCRIPTION

Example apparatus and methods concern additional actions performed by a TLC that is configured to control a tape library that is configured with an active archive and an active vault. The additional actions facilitate more intelligent active vault operations and facilitate improved billing that may remove incentives to operate tape storage imprudently. Conventionally a TLC does what it is told by an application. Example apparatus and methods facilitate having a TLC acquire additional information to improve control of a tape library configured with an active vault.

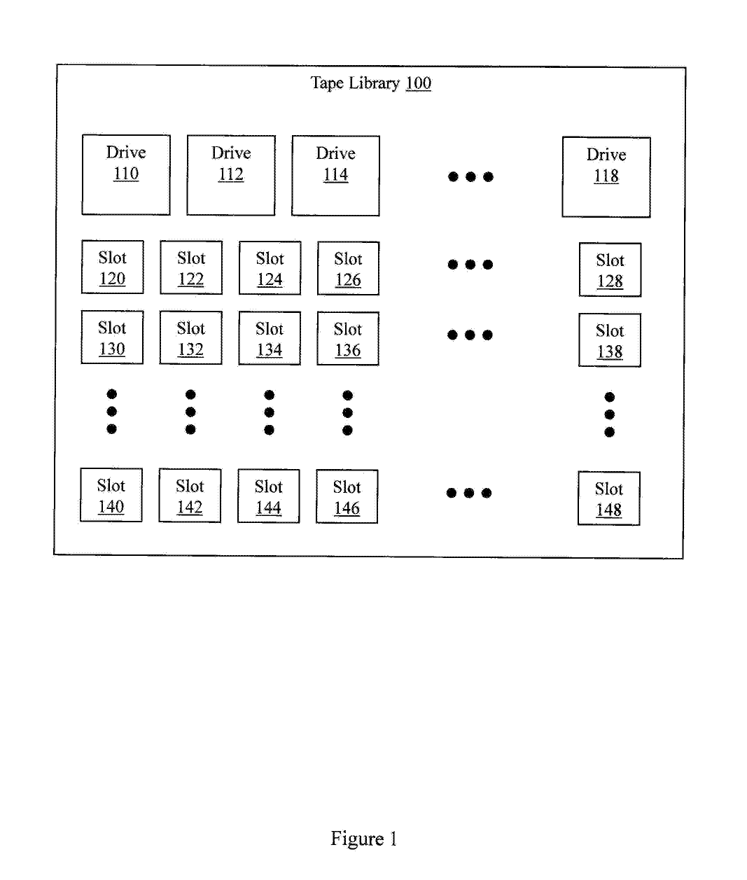

Conventionally a tape library included tape drives and tape slots. All the slots were substantially similar, both physically and logically. FIG. 1 illustrates a conventional tape library 100 that has a number of drives (e.g., 110, 112, 114, . . . 118) and a number of slots (e.g., 120, 122, 124, . . . 128, 130, 132, 134, 138, 140, 142, 144, . . . 148). All the drives may be treated as being fungible and all the slots may be treated as being fungible. An export command delivered to conventional tape library 100 may lead to a tape being moved from a drive or a slot to an ejection port and thus out of the tape library 100.

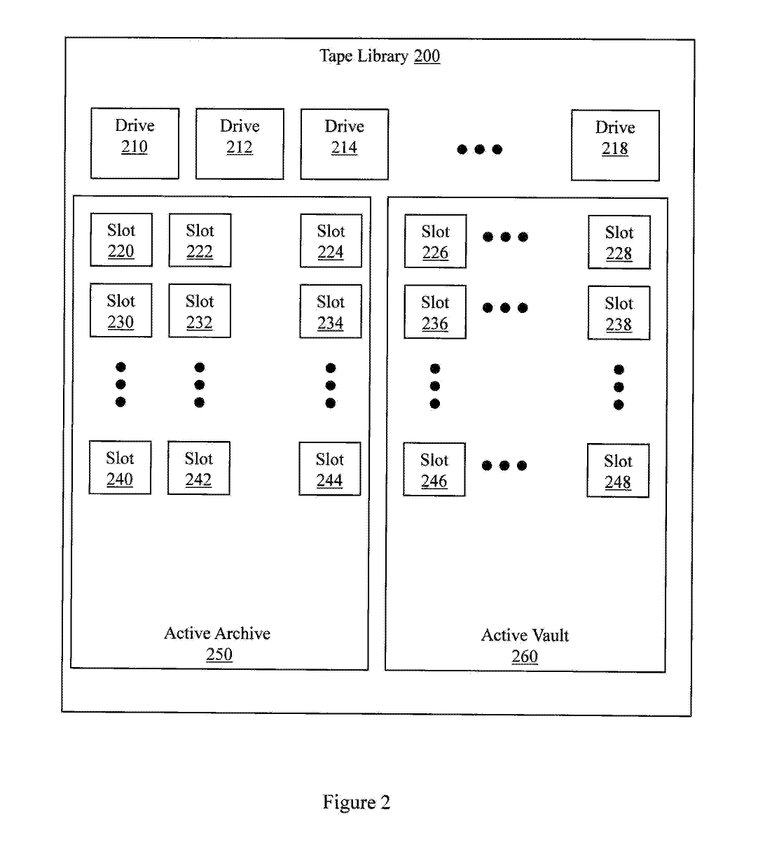

FIG. 2 illustrates a tape library 200 that is configured with an active archive 250 and an active vault 260. Tape library 200 includes a number of drives (e.g., 210, 212, 214, . . . 218). A tape library configured with an active archive and an active vault treats slots differently. Some slots may be allocated to the active archive and some slots may be allocated to the active vault. For example, slots 220, 222, 224, 230, 232, 234, 240, 242, and 244 may be allocated to an active archive 250 while slots 226 . . . 228, 236 . . . 238, and 246 . . . 248 may be allocated to an active vault 260. Since both the active archive 250 and the active vault 260 are located inside the tape library 200, tapes may be easily moved between the two portions. To remove incentives to act imprudently by micro-managing or gaming data management and tape storage pricing schemes, active vault slots may be made available at a less expensive price than active archive slots. In one embodiment, a high capacity additional tape storage device may perform the role of the active vault, in which case the active vault may not be physically located in the tape library 200 but may be integrated with or otherwise connected to the tape library 200.

As described above, some users may prefer to move tapes from the tape library to an external vault in an attempt to reduce costs. However, manually removing cartridges from the tape library can actually increase costs when tapes are lost or damaged. Additionally, if a tape is lost, a name space being maintained for data residing on the lost tape may become corrupted. Therefore, example apparatus and methods allow a TLC to seek additional information from a data management apparatus or application when the TLC receives a command that could be satisfied using the active vault instead of an external vault. Instead of automatically using an external vault when an export or import command is received, an example TLC can ask a data management application or apparatus that provided the import/export command for additional information. In one embodiment, an example TLC may look on a tape itself for more information. The additional information may control whether an active vault or an external vault is used for a vault command (e.g., import from vault, export from vault) that will cause a vault interaction.

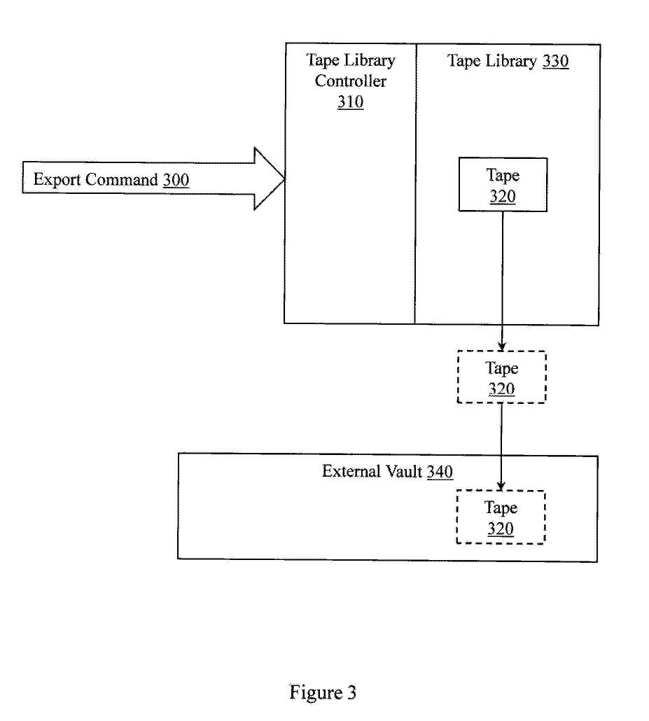

Before tape libraries were divided into an active archive and an active vault, or before tape libraries had active vaults available to them, export commands led to a tape being ejected automatically from the tape library. FIG. 3 illustrates this situation, where an export command 300 is received by a TLC 310 and then the TLC 310 causes a tape 320 to be ejected from the tape library 330. The tape 320 may have ended up in an external vault 340. Thus, in the situation illustrated in FIG. 3, an export command automatically led to an export operation that caused a tape to be ejected from a tape library.

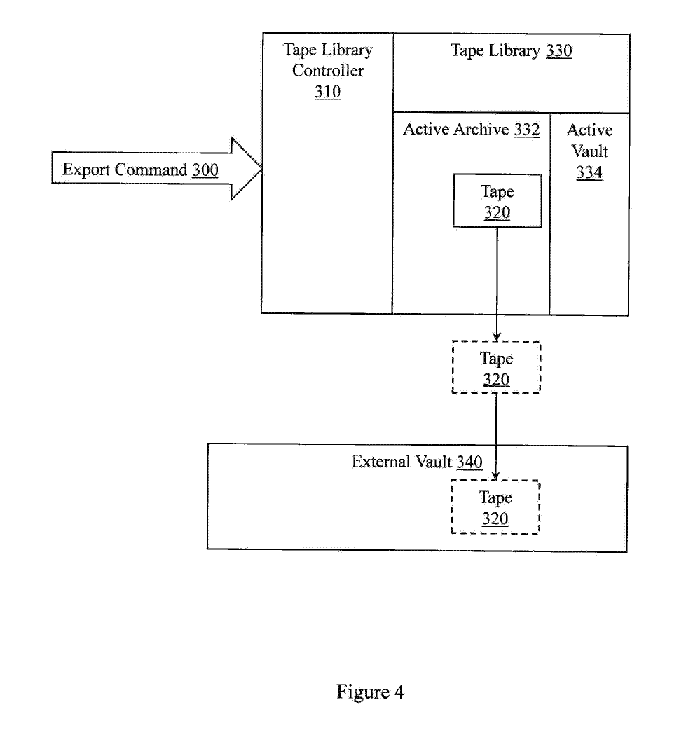

After tape libraries began to be divided into active archives and active vaults, or after active vaults become available to tape libraries, an export command that did not explicitly identify a vault destination could still automatically lead to an export operation. In FIG. 4, the tape library 330 has been divided into an active archive 332 and an active vault 334. However, export command 300 still leads to tape 320 being ejected from the tape library 330 even though it could, theoretically, be exported from the active archive 332 to the active vault 334.

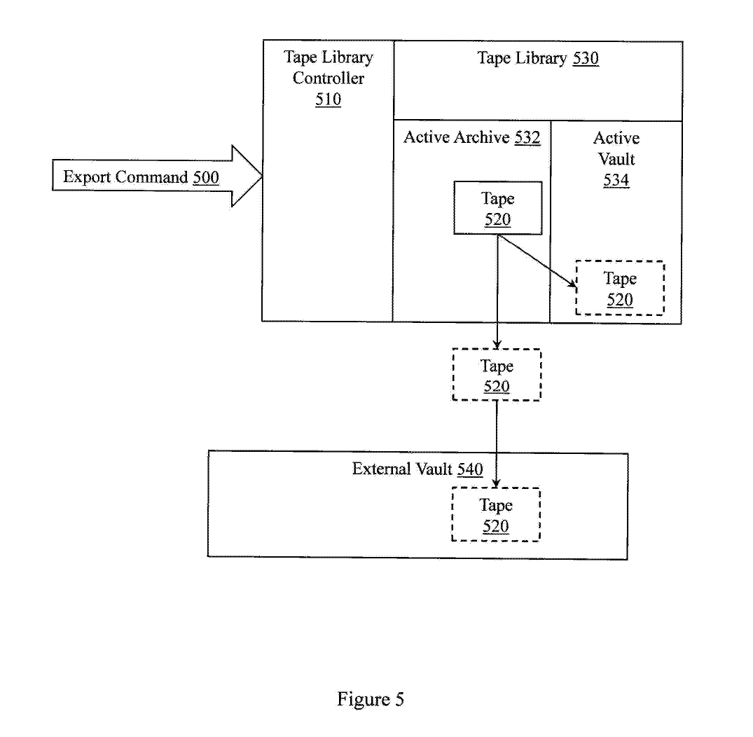

Example apparatus and methods facilitate the operations illustrated in FIG. 5. In FIG. 5, the tape library 530 has been divided into an active archive 532 and an active vault 534. In FIG. 5, an export command 500 may lead the TLC 510 to either export a tape 520 from the active archive 532 to the active vault 534 or to an external vault 540. Similarly, an import command could lead to a tape being brought into the active archive 532 from the active vault 534 or from the external vault 540. In response to receiving the export command 500, the TLC 510 may send a request back to the application that provided the export command 500. The request may seek information about whether the export is really intended to remove a tape from the tape library 530 or whether the export can be satisfied by moving a tape from the active archive 532 to the active vault 534.

Applications like StorNext® from Quantum Corporation may maintain a logical picture of a user's data while providing services like replication, de-duplication, and multi-tiered storage. Devices like the Scalar i6000 from Quantum Corporation may participate in maintaining the physical data associated with the logical picture of a user's data. Applications communicate with devices. For example, an application may tell a device to acquire a certain piece of data or a file. Similarly, an application may tell a device to store a certain piece of data or a file. Conventionally the device simply did what it was told. However, with the availability of an active vault, example apparatus and methods may not automatically just eject a tape in response to receiving an export command. Instead, example apparatus and methods may probe more deeply into an export command to see whether an active vault operation can be used to satisfy the export command. Additionally, example apparatus and methods may take the opportunity provided by communicating with the requesting application to perform finer-grained billing. For example, rather than simply ejecting a tape and thus no longer counting the tape against a user's tape capacity, example apparatus and methods may bill the user for creating additional risk by foregoing the opportunity to use the safer active vault and may bill the user for maintaining the namespace for the data even though the data now resides external to the tape library.

While export operations have been described, example apparatus and methods provide a similar opportunity for additional communications and billing for import operations. When a request for data or a file is made and that request cannot be satisfied by a tape that is currently in the active archive, then a console message may be generated. The console message informs an operator that a manual operation may be required to provide the tape to the active archive. However, when an active vault is available, a manual operation may not be needed. Instead, the tape may be available in the active vault and may be transferred by the tape library upon determining that an active vault operation is preferred over an external vault operation.

When tapes are stored in the active vault instead of in an external vault, the tapes may be included in extended data life management (EDLM) operations. EDLM involves unobtrusively and proactively checking the health of data or tapes by performing data integrity checking. EDLM may be controlled by an automated user policy. When used with some applications (e.g., StorNext®), EDLM may be configured to migrate data from a suspect tape to a new or healthy tape.

EDLM may include performing different types of scans (e.g., level 1, level 2, level 3) that may take various amounts of time (e.g., 5 minutes, 20 minutes, 120 minutes). EDLM may scan tapes to determine whether they are good, suspect, or failing. EDLM may be controlled by a policy. A policy may include two parts. A first EDLM policy part may be a control part that identifies facts including, but not limited to, when a tape is to be scanned, how a tape is to be scanned, and which tape is to be scanned. A second EDLM policy part may be a results part that identifies what to do (e.g., notify, report) for different possible scan results (e.g., good, suspect, failed). EDLM policies may be established on a per representation basis. Tapes that are removed from the tape library and stored in an external vault may not be available for EDLM. When an active vault is available, EDLM may operate concurrently, in the background, to allow tapes to be scanned without impacting regular tape library operations.

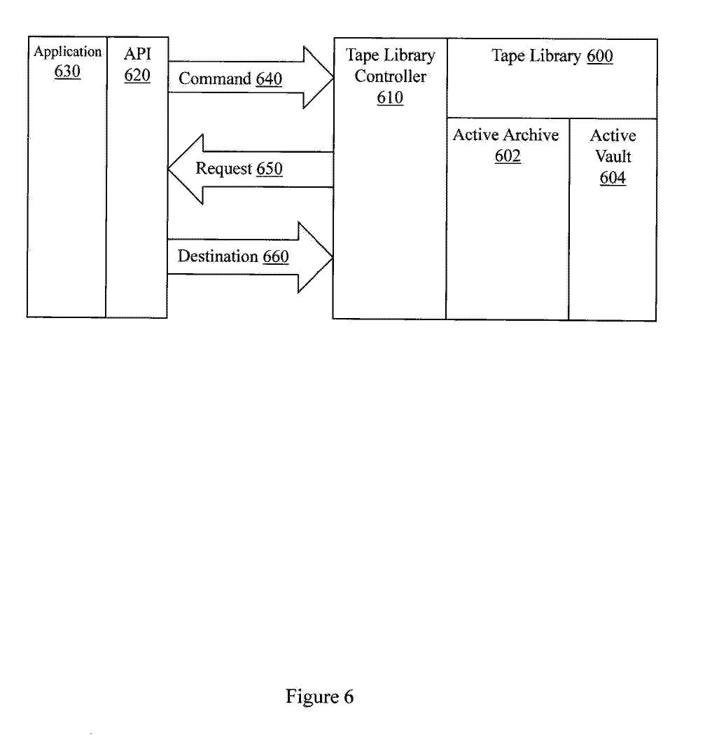

FIG. 6 illustrates a tape library 600 that includes an active archive 602 and an active vault 604. Operations of tape library 600 may be controlled by a TLC 610. TLC 610 may interact with an application 630 via an application programming interface (API) 620. The application 630 may send a command 640 to the TLC 610. The command 640 may be a vault command that will cause a vault interaction. TLC 610 may be configured to analyze incoming vault commands and then to selectively provide a request 650 back to the application 630 via the API 620. In response to receiving the request 650, the application 630 may provide a destination 660 to the TLC 610. In this way the TLC 610 may provide improved vault management for tape library 600.

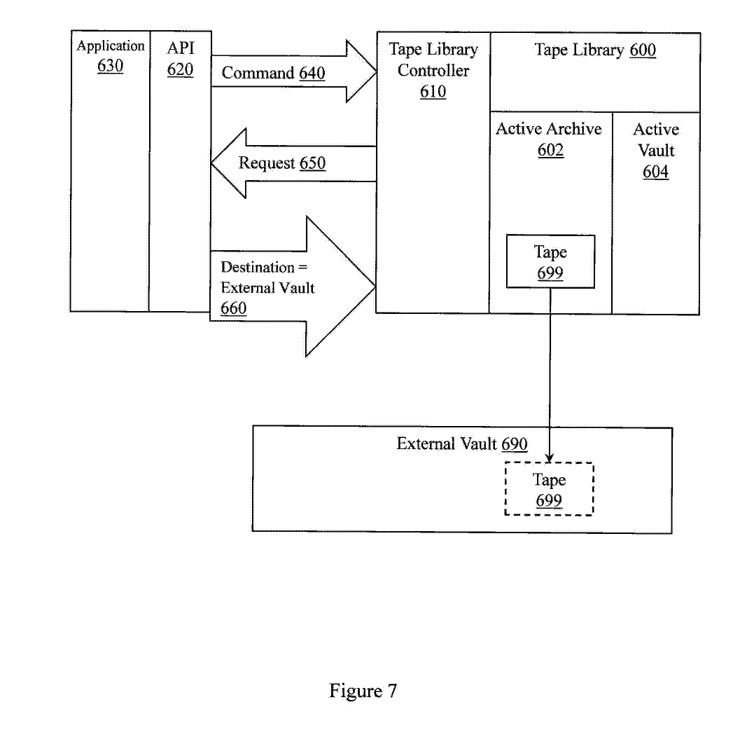

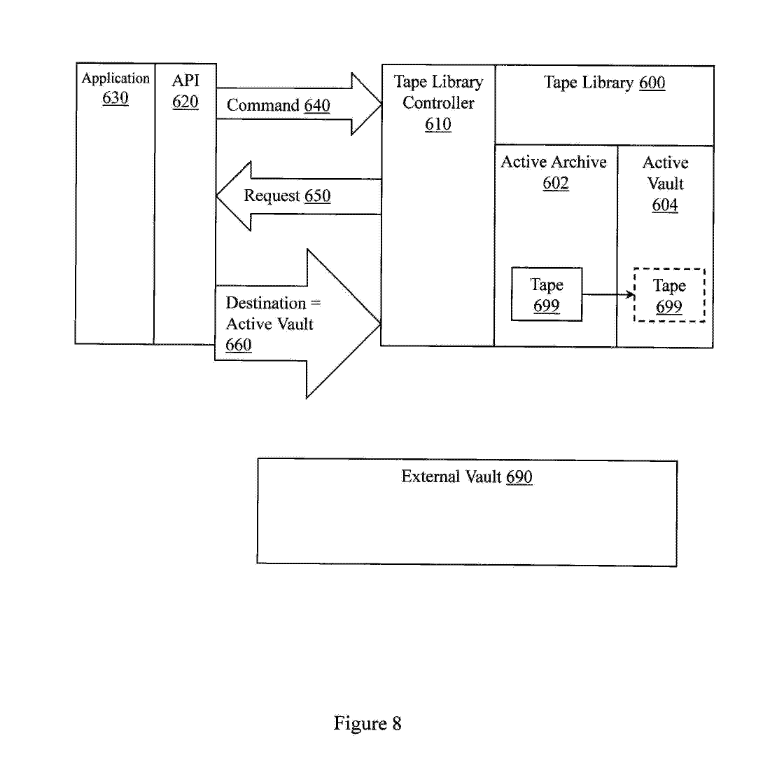

FIG. 7 illustrates one example where the destination 660 may indicate that the external vault 690 is to be used. In this example, a tape 699 may be ejected from the tape library 600 and stored in the external vault 690. FIG. 8 illustrates another example where the destination 660 may indicate that the active vault 604 is to be used. In this example, tape 699 may not be ejected from the tape library 600 but may instead be moved to the active vault 604. In either example, after the destination 660 is received, the TLC 610 can perform a billing action for the command 640. Since finer grained control of the vault operation is possible, finer grained billing may be performed. In one embodiment, billing may also be associated with enabling the feature. For example, an upfront license may be taken to allow configuring and using the feature. The upfront license may be used in place of, or in combination with, per event billing.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic. The physical manipulations create a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Blocks may be combined or separated into multiple components. Furthermore, additional or alternative methodologies can employ additional, not illustrated blocks.

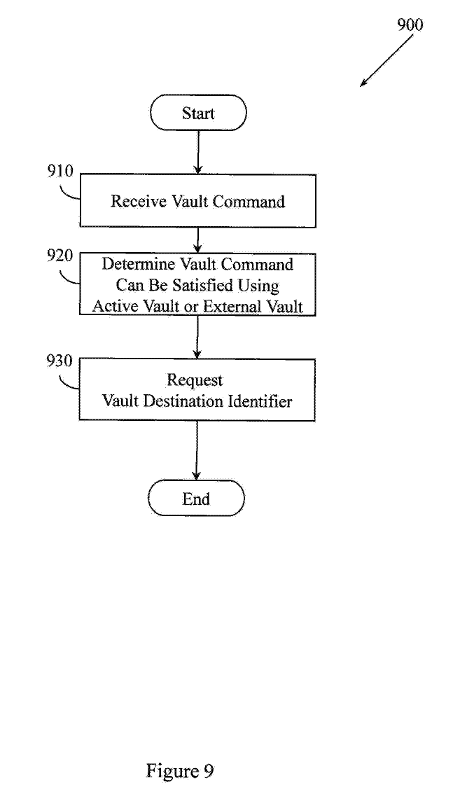

FIG. 9 illustrates an example method 900. Method 900 may be a computerized method for controlling the operation of a tape library that is configured with an active archive and an active vault. The active archive may be a collection of slots that are configured to receive a first level of service and to be billed using a first billing approach. The active archive may be configured to store managed data. The active vault may also be a collection of slots that are configured to receive a second level of service and that are billed using a second billing approach. The active vault may be configured to store un-managed data. In different embodiments, the active vault may be located inside the tape library or may be connected to or integrated with the tape library. For example, a tape library may have slots that are directly accessible by a single robotic operation or may have additional slots that are indirectly accessible by two or more robotic operations.

Method 900 includes, at 910, receiving a command in a TLC associated with the tape library. The command may be received, for example, from a data management application. The data management application may, for example, provide tiered storage for a user. The data management application may be configured to maintain a namespace for a user data set regardless of where the data resides in the multiple available tiers. The command may be, for example, a vault command that will cause a vault operation (e.g., export tape, import tape).

Method 900 may therefore include, at 920, determining that the command can be satisfied by one of, an operation involving the active vault, and an operation involving an external vault. Upon determining that at least two possibilities exist, method 900 may proceed, at 930, to control the TLC to provide a request for a vault identifier that identifies which vault is to be used to satisfy the command. Conventional systems do not make this request to identify a vault destination. Conventionally, if no vault destination is provided, a default operation (e.g., use external vault) will automatically occur. In one embodiment, the request may be provided to the data management application via the API. The request seeks a vault destination identifying which of the at least two possibilities (e.g., active vault, external vault) are to be used to satisfy the command.

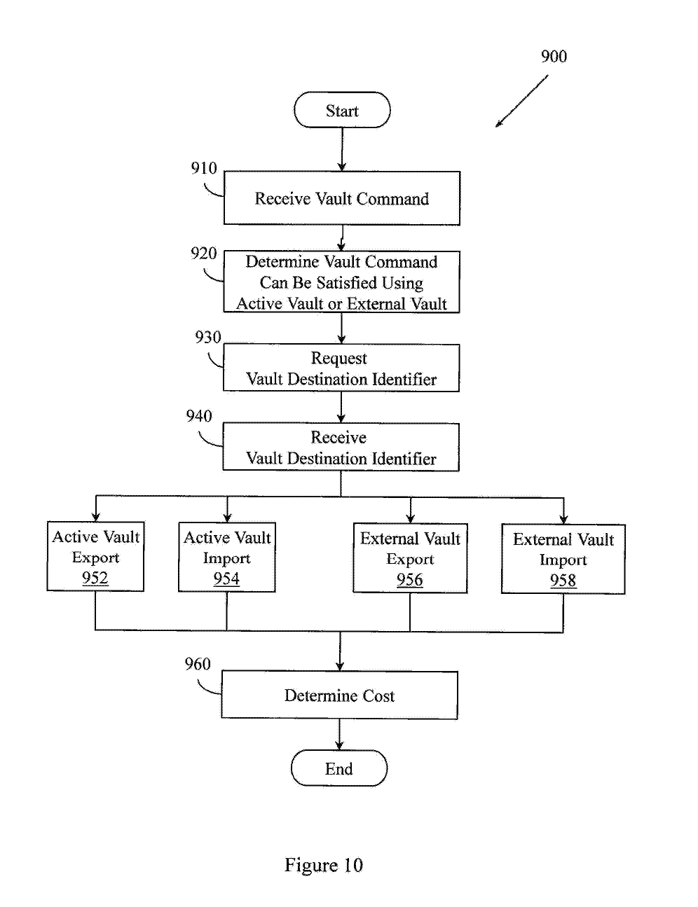

FIG. 10 illustrates another embodiment of example method 900. This embodiment includes the actions of receiving the command at 910, determining that the command can be satisfied by different vaults at 920, and requesting a vault identifier at 930. However this embodiment includes additional actions.

This embodiment of method 900 includes, at 940, receiving the vault identifier in the TLC. The vault identifier may be received from the data management application in response to the request provided at 930. The vault identifier may indicate which of the two possibilities (e.g., active vault, external vault) are to be used to satisfy the command. This produces at least four possibilities for the TLC and the tape library.

One possibility involves the command and the vault identifier indicating that the command is to be satisfied using an active vault export operation. In this case, method 900 proceeds, at 952, to control the tape library to export a tape from the active archive to the active vault. Exporting the tape from the active archive to the active vault may include, for example, moving the tape from a tape drive to a slot in the active vault, moving a tape from a slot in the active archive to the active vault, moving a tape from the tape library to a secondary automated device, and other actions.

Another possibility involves the command and the vault identifier indicating that the command is to be satisfied using an active vault import operation. In this case, method 900 proceeds, at 954, to control the tape library to import a tape from the active vault to the active archive. Importing the tape to the active archive from the active vault may include, for example, moving the tape from a slot in the active vault to a slot in the active archive, moving a tape from a slot in the active vault to a tape drive, moving a tape from a secondary automated device to the tape library, and other actions.

Another possibility involves determining that the command and the vault identifier indicate that the command is to be satisfied using an external vault export operation. In this case, method 900 proceeds, at 956, to control the tape library to eject a tape from the tape library. Exporting the tape from the active archive to the external vault may include, for example, moving the tape from a tape drive to an ejection port, moving a tape from a slot in the active archive to the ejection port, and other actions configured to remove a tape from a tape library.

Another possibility involves determining that the command and the vault identifier indicate that the command is to be satisfied using an external vault import operation. In this case, method 900 proceeds, at 958, to control the tape library to import a tape to the active archive. Importing the tape to the active archive from the external vault may include, for example, receiving a tape into the active archive from a source external to the tape library, and other actions that provide a tape to a tape library. The tape may be received via an eject/receive port on the tape library.

This embodiment of method 900 also facilitates taking advantage of additional billing opportunities and finer-grained billing. Method 900 may therefore include, at 960, determining a cost for an operation. In one example, upon determining that the command and the vault identifier indicate that the command is to be satisfied using the active vault, determining the cost may include determining a data management cost and a tape library capacity cost. In another example, upon determining that the command and the vault identifier indicate that the command is to be satisfied using the external vault, determining the cost may include determining a data management cost. Unlike conventional systems that may lose the opportunity to track costs when a tape is removed from a tape library, example apparatus and methods provide an additional opportunity to track costs. This opportunity arises due to the additional communications between the TLC and the requesting application.

Users may not wish to be involved in every decision involving every tape operation. Therefore, in one example, method 900 may include controlling the tape library based, at least in part, on policy information associated with the tape. The policy information may reside in different locations and may be provided to the TLC in different ways. In one example, the policy information is encoded in a bar code affixed to the cover of the tape, in a quick response (QR) code affixed to the cover of the tape, in a radio frequency identification (RFID) tag affixed to the cover of the tape, or in other locations. The policy information may control actions including which of an active vault operation and an external vault operation will be used to satisfy the command. For example, a user may prefer that a first tape be stored in an active vault and thus may have policy information recorded and available that indicates this preference. However, a user may prefer that a second tape be stored in an external vault and thus may have policy information recorded and available that indicates this preference.

In one example, method 900 may include selectively performing extended data life management (EDLM) on a tape stored in the active vault. The EDLM operations may be controlled, at least in part, by the policy information available for a tape.

While FIG. 10 illustrates various actions occurring in serial, it is to be appreciated that various actions illustrated in FIG. 10 could occur substantially in parallel. By way of illustration, a first process could receive commands, a second process could analyze commands, a third process could prepare and provide requests for vault destinations, a fourth process could process vault destinations, and a fifth process could perform cost determinations. While five processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor, TLC) cause the machine to perform methods described herein including method 900. While executable instructions associated with the above method are described as being stored on a computer-readable medium, it is to be appreciated that executable instructions associated with other example methods described herein may also be stored on a computer-readable medium.

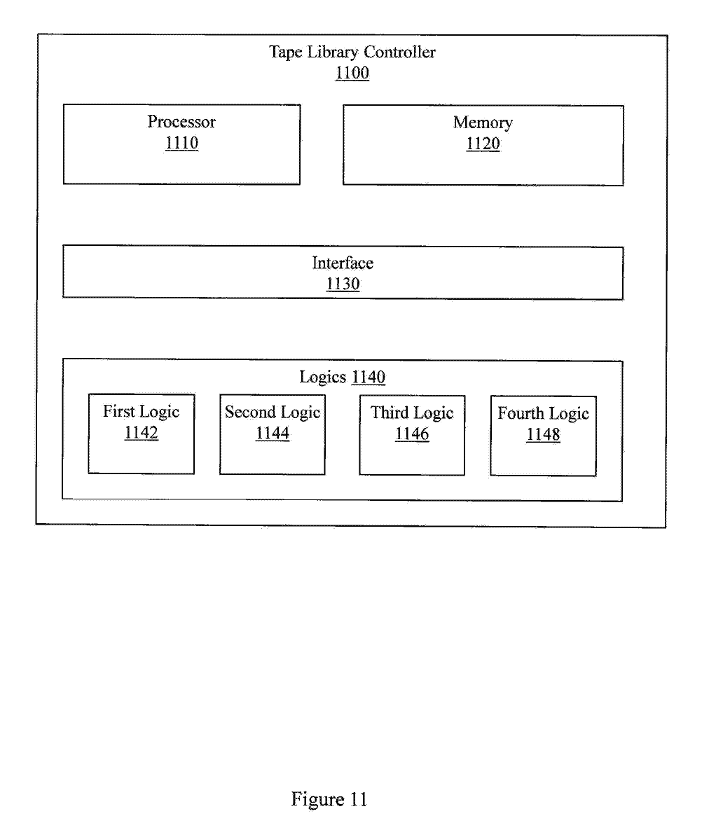

FIG. 11 illustrates an example TLC 1100. TLC 1100 includes a processor 1110, a memory 1120, and a set 1140 of logics. TLC 1100 also includes an interface 1130 that is configured to connect the processor 1110, the memory 1120, and the set 1140 of logics.

100521 The processor 1110 may be various processors including dual microprocessor and other multi-processor architectures. Memory 1120 may include volatile memory or non-volatile memory. Non-volatile memory may include, for example, read only memory (ROM), programmable ROM (PROM), and other types of memory. Volatile memory may include, for example, random access memory (RAM), dynamic RAM (DRAM), and other types of memory.

The interface 1130 may be a single internal bus interconnect architecture or other bus or mesh architectures. While a single bus is illustrated, it is to be appreciated that the TLC 1100 may communicate with various devices, logics, and peripherals using other interfaces (e.g., PCIE, 1394, USB, Ethernet). The interface 1130 can be of types including, for example, a memory bus, a memory controller, a peripheral bus, an external bus, a crossbar switch, a local bus, or other interfaces.

The set 1140 of logics may include a first logic 1142 that is configured to receive a vault command from an application external to the TLC 1100. The vault command is a command that will cause an interaction with a vault. The vault may be an actual vault (e.g., active vault) or may be a theoretical vault (e.g., shelf, drawer, desktop, spot on floor) that is accessed through an interface (e.g., ejection port, importation port) in the tape library. The vault command may be an import command or an export command. As described above, the tape controller 1100 may be configured to control a tape library that has both an active vault and an external vault available. In one example, the first logic 1142 may be configured to receive the vault command.

Therefore, the set 1140 of logics may also include a second logic 1144 that is configured to request a vault destination for the vault command. The request may be sent to the application that provided the command. In one embodiment, the second logic 1144 may use the request to ask for a vault destination. In another embodiment, the second logic 1144 may use the request to provide information about vaults that are available to the TLC 1100 and to ask the application to pick one of the available vaults. In different examples the vault destination may be an active vault associated with a tape library that is controllable by the TLC, and an external vault. In one example, the second logic 1144 may be configured to request the vault destination from the application via the API. Thus, the second logic 1144 may make a remote procedure call, may send information to a socket, may place data in a shared memory location, or may take other actions.

The set 1140 of logics may also include a third logic 1146 that is configured to receive the vault destination from the application. Receiving the vault destination may include receiving a communication from the application, detecting a signal on a control line between an external apparatus and the TLC 1100, or other actions. The communication may be received in response to a query or request for the information. In one example, the third logic 1146 may be configured to receive the vault destination from the application.

The set 1140 of logics may also include a fourth logic 1148 that is configured to control the tape library to perform the vault operation using the vault destination. Since the fourth logic 1148 controls the tape library to perform the vault operation, the fourth logic 1148 may also be configured to update billing data associated with the vault command. The billing data may include, for example, a current number of active archive slots being used by a user, a current number of active vault slots being used by a user, an amount of managed data associated with the user, and other data. While the fourth logic 1148 is described as the logic that updates the billing data, in different examples the billing data may be updated by other logics.

In one embodiment, the TLC 1100 may be a part of a tape library. The tape library may include a tape drive(s), and slots. The slots may be arranged in two or more groups. A first set of tape slots may be configured as an active archive and a second set of tape slots may be configured as an active vault. While four separate logics 1142, 1144, 1146, and 1148 are illustrated, one skilled in the art will appreciate that the functionality provided by the four logics may be provided by a greater or lesser number of logics.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, “an example”, and other similar terms, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a medium that stores instructions or data. A computer-readable medium may take forms, including, but not limited to, non-volatile media, and volatile media. Non-volatile media may include, for example, optical disks, magnetic disks, and other disks. Volatile media may include, for example, semiconductor memories, dynamic memory, and other memories. Common forms of a computer-readable medium may include, but are not limited to, a floppy disk, a flexible disk, a hard disk, a magnetic tape, other magnetic medium, an application specific integrated circuit (ASIC), a compact disk (CD), other optical medium, a RAM, a ROM, a memory chip or card, a memory stick, and other media from which a computer, a processor or other electronic device can read.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical items. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

While example apparatus, methods, and computer-readable media have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, or ABC (e.g., the data store may store only A, only B, only C, A&B, A&C, B&C, or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computerized method for controlling the operation of a tape library configured with an active archive and an active vault, the method comprising:
receiving a command in a tape library controller associated with the tape library, where the tape library is configured with an active archive and an active vault, where the command is received from a data management application; and
upon determining that the command can be satisfied by one of, an operation involving the active vault, and an operation involving an external vault, controlling the tape library controller to provide a request to the data management application, where the request seeks a vault identifier that identifies which of the active vault and the external vault are to be used to satisfy the command.

2. The method of claim 1, comprising:
receiving the vault identifier in the tape library controller from the data management application.

3. The method of claim 2, comprising:
upon determining that the command and the vault identifier indicate that the command is to be satisfied using an active vault export operation, controlling the tape library to export a tape from the active archive to the active vault.

4. The method of claim 2, comprising:
upon determining that the command and the vault identifier indicate that the command is to be satisfied using an active vault import operation, controlling the tape library to import a tape from the active vault to the active archive.

5. The method of claim 2, comprising:
upon determining that the command and the vault identifier indicate that the command is to be satisfied using an external vault export operation, controlling the tape library to eject a tape from the tape library.

6. The method of claim 2, comprising:
upon determining that the command and the vault identifier indicate that the command is to be satisfied using an external vault import operation, controlling the tape library to receive a tape into the active archive from a source external to the tape library.

7. The method of claim 2, comprising:
upon determining that the command and the vault identifier indicate that the command is to be satisfied using the active vault, controlling the tape library to determine a cost associated with the command, where the cost includes a data management cost and a tape library capacity cost; and
upon determining that the command and the vault identifier indicate that the command is to be satisfied using the external vault, controlling the tape library to determine a cost associated with the command, where the cost includes a data management cost.

8. The method of claim 1, comprising:
selectively controlling the tape library controller to provide the request to the data management application upon determining that active vault operations have been configured and paid for.

9. The method of claim 1, comprising:
controlling the tape library based, at least in part, on policy information associated with the tape.

10. The method of claim 9, where the policy information is encoded in one or more of, a bar code affixed to the cover of the tape, a quick response (QR) code affixed to the cover of the tape, and a radio frequency identification (RFID) tag affixed to the cover of the tape.

11. The method of claim 9, where the policy information controls, at least in part, which of an active vault operation and an external vault operation will be used to satisfy the command.

12. The method of claim 1, comprising:
selectively performing extended data life management (EDLM) on a tape stored in the active vault.

13. A tape library controller, comprising:
a processor;
a memory;
a set of logics; and
an interface configured to connect the processor, the memory, and the set of logics,
the set of logics comprising:
a first logic configured to receive a vault command from a computer application external to the tape library controller, where the vault command will cause an interaction between a tape library controlled by the tape library controller and a vault;
a second logic configured to request from the computer application a vault destination identifier for the vault command, the vault destination being one of, an active vault associated with the tape library, and an external vault;
a third logic configured to receive the vault destination identifier from the computer application; and
a fourth logic configured to control the tape library to perform the vault operation using the vault destination identified by the vault destination identifier.

14. The tape library controller of claim 13, the vault command being one of, an export command, and an import command.

15. The tape library controller of claim 13, the second logic being configured to provide to the computer application information about vaults that are available to be the vault destination.

16. The tape library controller of claim 13, the fourth logic being configured to update billing data associated with the vault command.

17. A tape library, comprising:
a tape drive;
a first set of tape slots configured to hold tapes suitable for use in the tape drive, the first set being configured as an active archive;
a second set of tape slots configured to hold tapes suitable for use in the tape drive, the second set being configured as an active vault; and
a tape library controller configured to control an operation of the tape library, the tape library controller comprising:
a processor;
a memory;
a set of logics; and
an interface configured to connect the processor, the memory, and the set of logics,
the set of logics comprising:
a first logic configured to receive a vault command, where the vault command will cause an interaction between the tape library and a vault;
a second logic configured to request a vault destination for the vault command, the vault destination being one of, the active vault, and an external vault;
a third logic configured to receive the vault destination; and
a fourth logic configured to control the tape library to perform the vault operation using the vault destination.
